(19) United States
(12) Patent Application Publication
(10) Pub. No.: US 2013/0042512 A1
(43) Pub. Date: Feb. 21, 2013

(54) RECORDING DATA DEVICE

(71) Applicant: Kyle M. Perfette, Peoria, AZ (US)

(72) Inventor: Kyle M. Perfette, Peoria, AZ (US)

(21) Appl. No.: 13/695,694

(22) PCT Filed: May 27, 2011
(86) PCT No.: PCT/US11/38402

§ 371 Date: Nov. 1, 2012

Related U.S. Application Data
(60) Provisional application No. 61/395,283, filed on May 12, 2010.

(51) Int. Cl. G09F 3/10; A44C 5/00

(52) U.S. Cl. 40/633

(57) ABSTRACT

The present disclosure provides a recording data device with information set categorizing data preprinted on a medium or on a label to be attached to the medium. Specifically, the device may be used to record patient's vital signs in an emergency situation.

### FIELD OF THE INVENTION

The present invention provides a recording data device for providing a convenient, handy and user-friendly way of recording data in various situations.

### BACKGROUND OF THE INVENTION

There are situations where a set of data reflecting certain information need to be collected and recorded on site, especially when a quick assessment of information is required based on data collected, such as medical emergency sites, construction sites, physical training sites, there is a need for a recording data device that is convenient, handy and user-friendly.

### BRIEF DESCRIPTION OF THE FIGURES

FIG. 1 is a perspective view of a right hand recording data on a recording data device in accordance with the teachings of the instant invention as it would appear in use;

FIG. 2 is a top plan view of a recording data device;

FIG. 3 is an enlarged fragmentary view of a recording data device;

FIG. 4 is a perspective view of a left hand recording data on a recording data in accordance with the teachings of the instant invention as it would appear in use;

FIG. 5 is a top plan view of a recording data device;

FIG. 6 is an enlarged fragmentary view of a recording data device; and

FIG. 7 is a schematic flow diagram illustrating a preferred method of using a recording data device in accordance with the principles of the present invention.

FIG. 8 is a preprinted label that can be attached to a recording data device.

### DETAILED DESCRIPTION

The present invention discloses a recording data device. Specifically, the device comprises a medium carrying data to be recorded and information sets categorizing data to be recorded. The medium of the device may be a glove, a wrist band, or an arm band. The information set maybe preprinted on the medium, or preprinted a self-adhesive label that can be stick to the medium.

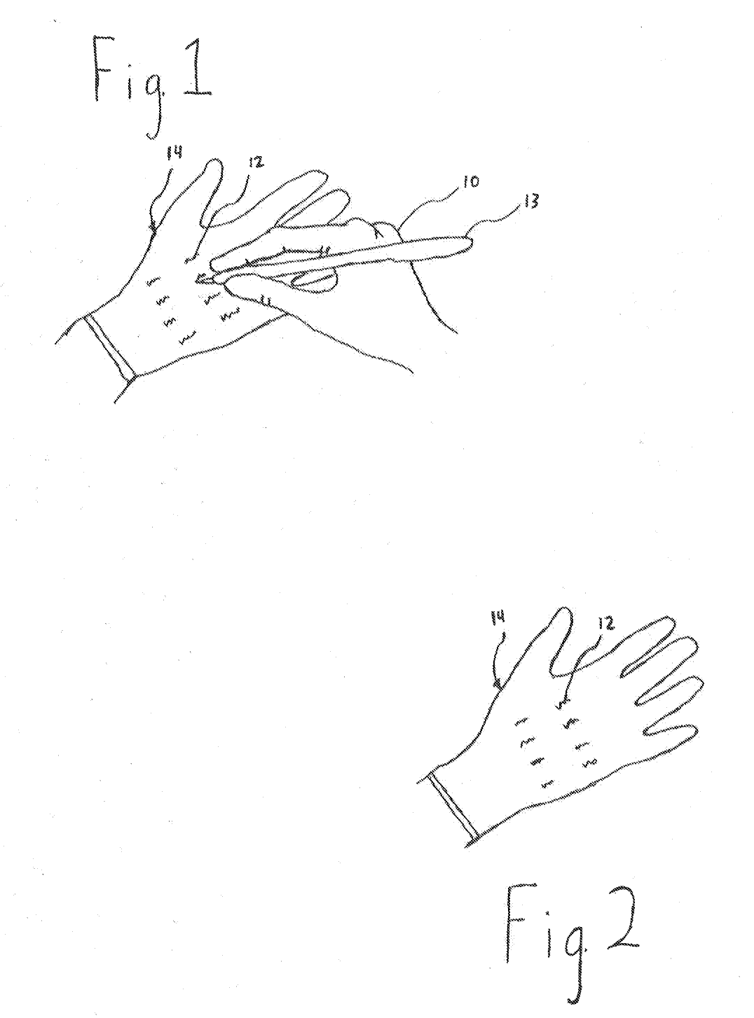

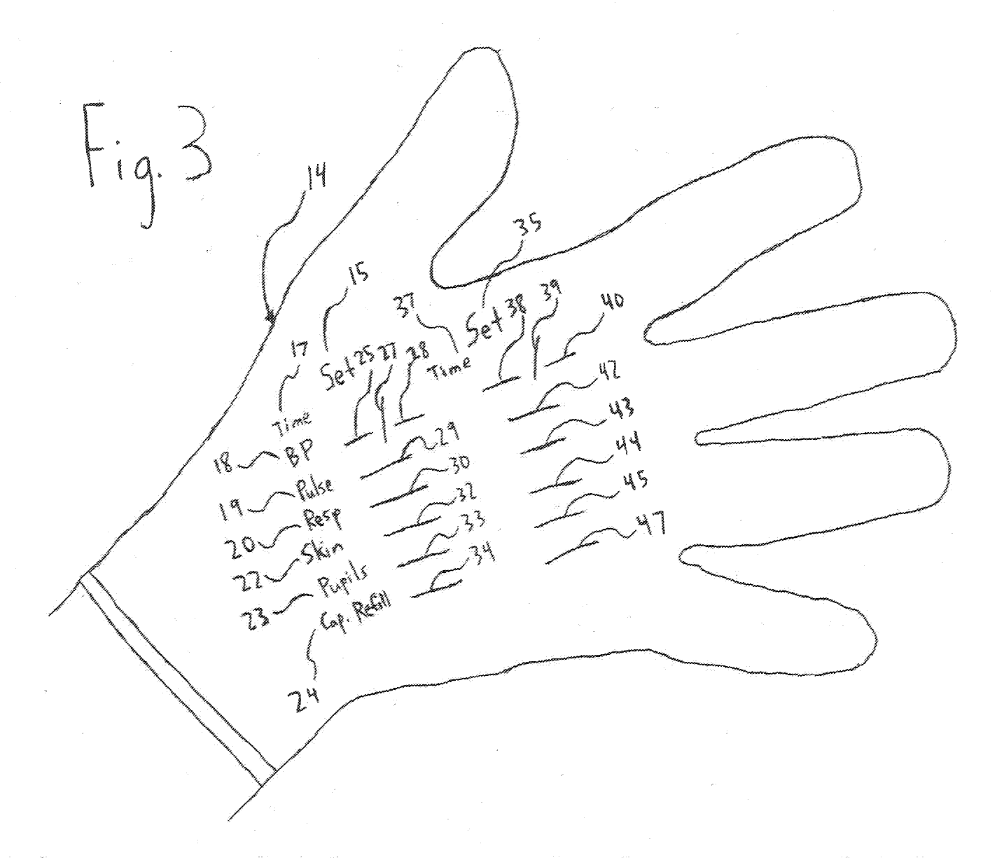

FIG. 1 shows reference characters indicating corresponding elements throughout the several views. In FIG. 1 it is shown that a right hand 10, which can also be a left hand, is recording data or information 12 with a writing utensil 13 on a recording data device on the left hand 14 or could be a right hand. With additional reference to FIG. 2, it is seen as a recording data device 14 with data or information 12 on it. With additional reference to FIG. 3, it is seen an enlarged recording data device 14 with information which can record data on it according to the information. In one embodiment the information is pre-printed on the device. In another embodiment, the information is later added by any method chosen from writing, printing, attaching a recordable label which may comprise preprinted information. FIG. 8 shows an exemplary preprinted label that may be attached to the device. In one embodiment, the information and data relates to a health-care setting, and in one exemplary example, the data recording device records patient's vital signs for emergency medical personnel. In another embodiment, the information and data relates to a construction or manufacturing setting, and in one exemplary example, the data recording device records information and data facilitating the performance of the personnel at construction or manufacturing sites.

Looking at FIG. 3, it is seen as a recording data device 14, which can be placed either on a left or right hand, or both hands that can include a number of things such as recording patient's vital signs. It can include the number of sets for taking the vitals (Set) 15. Also, the time in which the data will be recorded (Time) 17. Another piece of data that can be recorded is the blood pressure information (BP) 18, and multiple lines and/or slashes to separate the different pressures such as the systolic pressure line 25, slash (to separate the different pressures) 27 and the diastolic pressure line 28 in which the information collected can be written down. Another piece of data that can be recorded is the pulse (Pulse) 19 and a line 29 in which the information collected can be written down.

Another piece of data that can be recorded is the respiration's (Resp.) 20 and a line 30 in which the information collected can be written down. Another piece of data that can be recorded is the skin (Skin) 22 and line 32 in which the information can be written down. Another piece of data the can be recorded is the pupils (Pupils) 23 and a line 33 in which the information collected can be written down. Another piece of data the can be recorded is the capillary refill (Cap. Refill) 24 and a line 34 in which information collected can be written down.

It can also record another set of vitals 35 and the time which taking the vitals 37. Begin recording the patient's vitals as outlined in the previous paragraph. There are multiply lines and/or slashes to record data for the next set such as the systolic and diastolic pressure and can be recorded on the line 28 slash (to separate the different pressures) 39 and another line 40 and the pulse can be recorded and written down on the line 42. The respirations can be recorded and written down on the line 43. The skin can be recorded and written down on the line 44. The pupils can be recorded and written down on the line 45. The capillary refill can be recorded and written down on the line 47.

In order to use, take recording data device out of container and place one on right hand and one on left hand. Using a writing utensil, write down the patient's vital signs as outlined in the previous procedures. The information can be recorded on the recording data device either on the right or left hand on the outside or inside of the hand for each vital sign that will be taken.

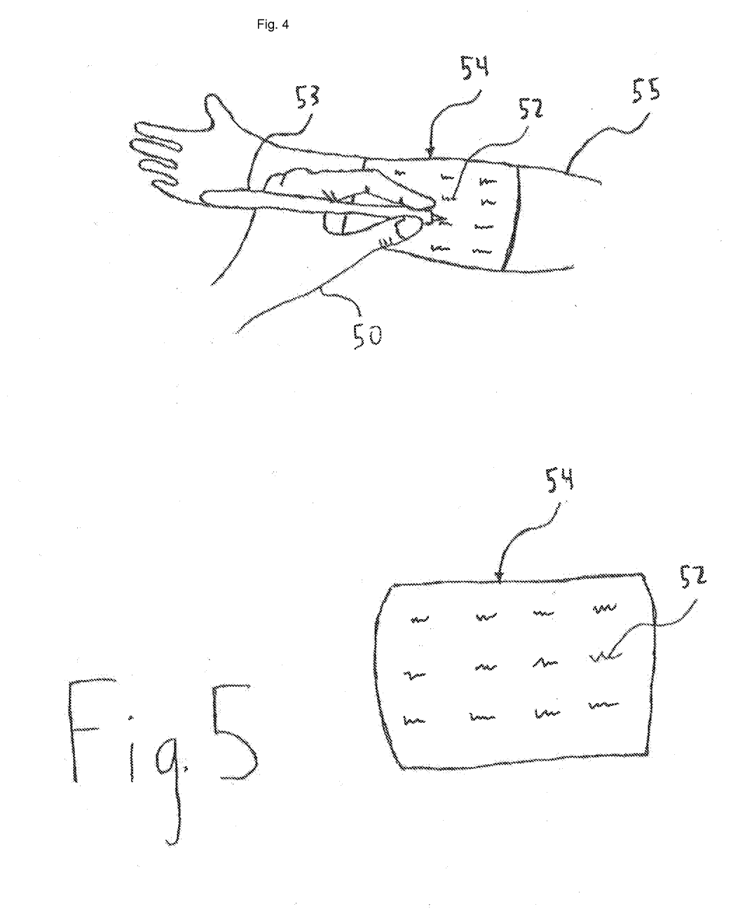

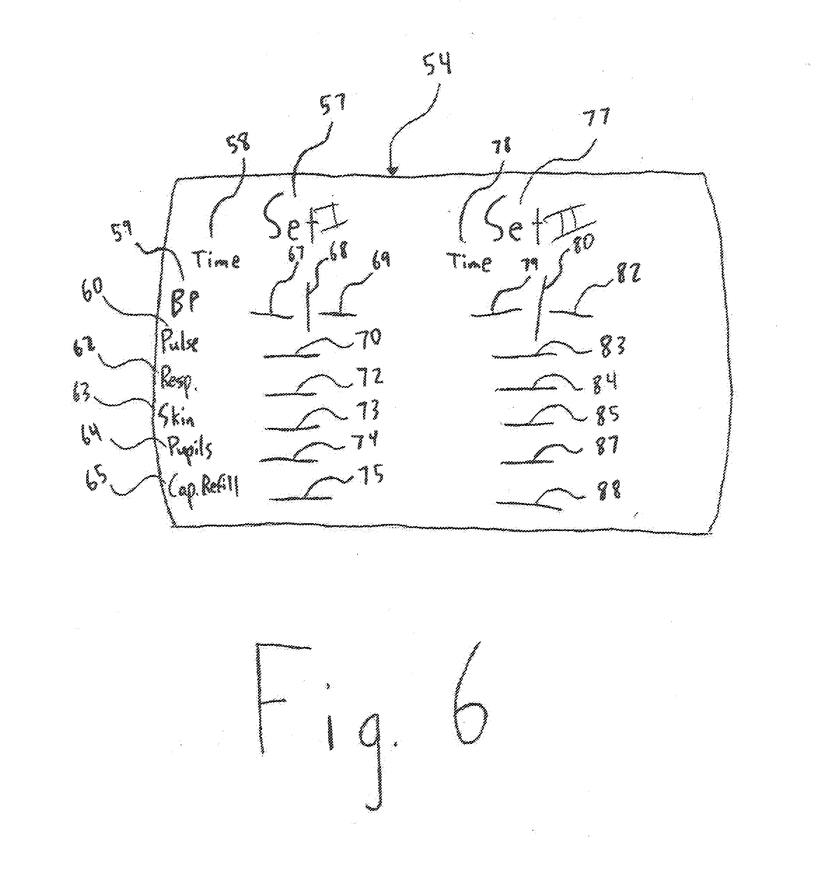

Referring now to FIG. 4, which is seen as a left hand 50 or could be a right hand recording data 52 using a writing utensil 53 on a recording data device 54 on a right arm 55 or could be on a left arm. With additional reference to FIG. 5, it is seen as a recording data device 54 with information 52 on it. With additional reference to FIG. 6, it is seen as an enlarged recording data device 54 with information on it, which can record data for personal use such as patient's vital signs.

Looking at FIG. 6, it is seen as a recording data device which can placed on a left or right arm, or both arms that can be used to record a number of things such as recording patients vital signs. It can include the number of sets for taking the vitals (Set) 57. Also, the time in which the data will be recorded (Time) 58. Another piece of data that can be recorded is the blood pressure information (BP) 59, and multiple lines and/or slashes to separate the different pressures such as the systolic pressure line 67, slash (to separate the different pressures) 68 and the diastolic pressure line 69 in which the information collected can be written down.

Another piece of data that can be recorded is the pulse (Pulse_1 and a line 70 in which the information collected can be written down. Another piece of data that can be recorded is the respiration's (Resp.) 62 and a line 72 in which the information collected can be written down. Another piece of data that can be recorded is the skin (Skin) 63 and line 73 in which the information can be written down. Another piece of data the can be recorded is the pupils (Pupils) 64 and a line 74 int which the information collected can be written down. Another piece of data the can be recorded is the capillary refill (Cap. Refill) 65 and a line 75 in which information collected can be written down.

It can also record another set of vitals 77 and the time which taking the vitals 78. Begin recording the patient's vitals as outlined in the previous paragraph. There are multiply lines and/or slashes to record data for the next set such as the systolic and diastolic pressure and can be recorded on the line 79 slash (to separate the different pressures) 80 and another line 82 and the pulse can be recorded and written down on the line 83. The respiration's can be recorded and written down on the line 84. The skin can be recorded and written down on the line 85. The pupils can be recorded and written down on the line 87. The capillary refill can be recorded and written down on the line 88.

In order to use, take recording data device out of container and place one on right arm. arid one on left arm. Using a writing utensil, write down the patient's vital signs as outlined in the previous procedures. The information can be recorded on the recording data device either on the right or left arm on the outside or inside of the arm for each vital sign that will he taken.

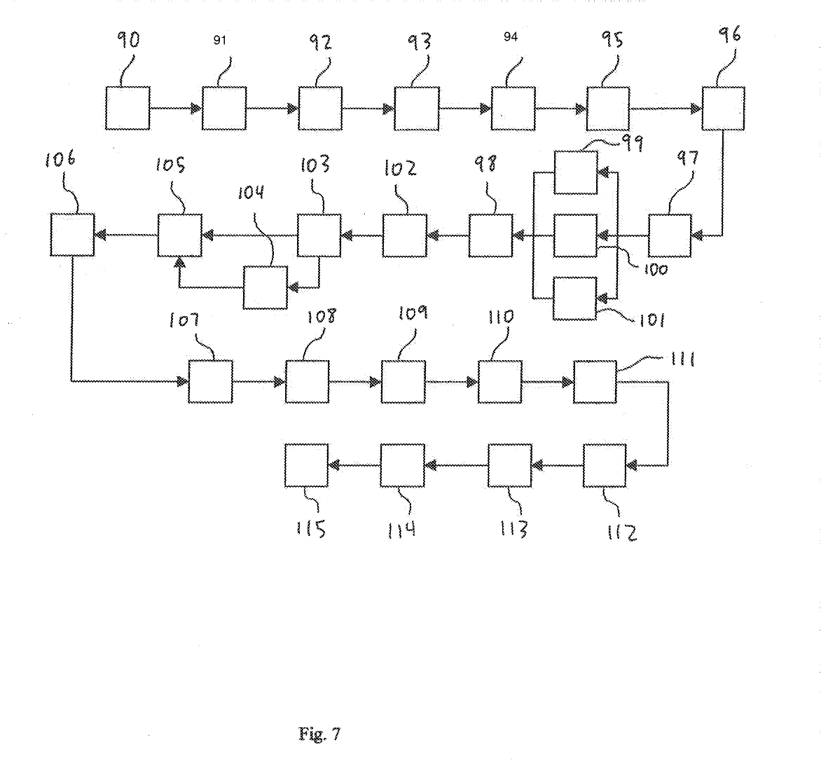

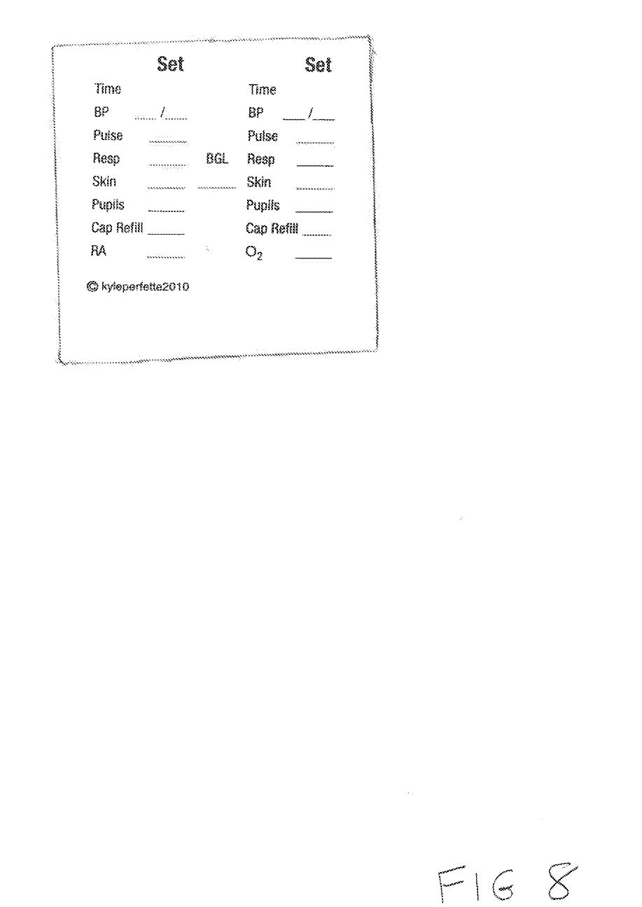

Attention is directed to FIG. 7 in which is seen as emergency medical personnel 90 at the fire station 91. Someone calls 911 for an emergency 92. Dispatch receives message from caller 93 and alerts the station 94 dispatch gives brief description of what the call is and where it is at 95. Emergency response personnel receive message 96. Emergency response personnel go to vehicle 97 and get into vehicle 98, however personnel take several vehicles such as the rescue 99, engine 100, and ladder truck 101 depending on the type of emergency response.

Emergency response personnel go to the scene 102. and arrive at the scene 103, and some emergency response personnel were able to put on their recording data device containing vital signs while on route to the scene 104. Emergency response personnel get out of their vehicle 105 and put recording data device containing vital signs on 106 (if were unable to when in route to the scene) and retrieves equipment 107 and respond to the patient location 108. Emergency response personnel assess patient 109 and treats patient 110.

Emergency response personnel write down vital signs on the recording data device 111. Emergency response personnel relays information on recording data device with vital signs to partner recording the information on EMS (emergency medical service) form 112. Emergency response personnel determine whether to transport patient 113 to hospital 114 or patient refuses transport to hospital 115.

There can also be other uses of the invention such as recording athletic statistics including speed, agility, and jumping. Another use could be recording information while constructing a house including the length, width, and depth of an object. Another use could be recording inventory including but not limited to the prices, quantity of products, and how many of each product there is on display.

The foregoing description of a preferred embodiment and best mode of the invention known to the applicants at this time of filing the application has been presented and is intended for the purposes of illustration and description. It is not intended to be exhaustive or limit the invention to the precise form disclosed and many modifications and variations are possible in the light of the above teachings. The embodiment was chosen and described in order to best explain the principles of the invention and its practical application and to enable others skilled in the art to best utilize the invention in various embodiments and with various modifications as are suited to the particular use contemplated. Therefore, it is intended that the invention not be limited to the particular embodiments disclosed for carrying out this invention, but that the invention will include all embodiments falling within the scope of the appended claims.

What is claimed is:

1. A recording data device for recording data, comprising:
a medium carrying data to be recorded, wherein the medium is a glove, a wrist hand, or an arm band;
information sets categorizing data to be recorded.

2. The recording data device in claim 1, wherein the information sets are preprinted on the medium.

3. The recording data device in claim 1, wherein the information sets are preprinted on a self-adhesive label, and the label can be attached to the medium for data recording.

4. The recording data device in claim 1, wherein the information sets are related to patient's vital signs.
